(19) United States
(12) Patent Application Publication
(10) Pub. No.: US 2015/0156651 A1
(43) Pub. Date: Jun. 4, 2015

(54) DETECTION OF USER TERMINAL DISTRIBUTION IN A WIRELESS COMMUNICATION SYSTEM

(71) Applicants: Andreas Nilsson, Goteborg (SE); Fredrik Athley, Kullavik (SE); Mikael Coldrey, Landvetter (SE)

(72) Inventors: Andreas Nilsson, Goteborg (SE); Fredrik Athley, Kullavik (SE); Mikael Coldrey, Landvetter (SE)

(73) Assignee: TELEFONAKTIEBOLAGET L M ERICSSON (PUBL), Stockholm (SE)

(21) Appl. No.: 14/402,817

(22) PCT Filed: May 25, 2012
(86) PCT No.: PCT/EP2012/059838

§ 371 Date: Nov. 21, 2014

(51) Int. Cl. H04W 24/08

(52) U.S. Cl. CPC H04W 24/08

(57) ABSTRACT

The present invention relates to a node (1) in a wireless communication network, the node (1) comprising at least one antenna arrangement (2, 3, 4). Each antenna arrangement (2, 3, 4) comprises at least two spatially separated antenna functions (5, 6, 7, 8) and is arranged to communicate with a corresponding plurality of user terminals (9, 10, 11, 12) and also to receive information from each one of said user terminals (9, 10, 11, 12). Said information comprises data enabling the node (1) to control beamforming for each antenna arrangement (2, 3, 4) towards said user terminals (9, 10, 11, 12).The node (1) further comprises a control unit (13) that is arranged to analyze said data and, from the analysis of said data, to determine how said user terminals (9, 10, 11, 12) are distributed within a certain angular span (14) for each antenna arrangement (2, 3, 4). The present invention also relates to a corresponding method.

### TECHNICAL FIELD

The present invention relates to a node 1 in a wireless communication network, the node comprising at least one antenna arrangement. Each antenna arrangement comprises at least two spatially separated antenna functions and is arranged to communicate with a corresponding plurality of user terminals and also to receive information from each one of said user terminals. Said information comprises data enabling the node to control beamforming for each antenna arrangement towards said user terminals.

The present invention also relates to method for determining how a plurality of user terminals is distributed within a certain angular span. The method comprises the step of receiving information from each one of said user terminals at a wireless communication network node, said information comprising data enabling the node to control beamforming for an antenna arrangement towards said user terminals.

### BACKGROUND

Future generations of cellular networks are expected to provide high data rates, up to 1 Gbps, while at the same time being energy efficient. One relatively unexplored way to achieve such high data rates and/or to lower the energy consumption in cellular networks is to deploy reconfigurable antenna systems. A reconfigurable antenna system is an antenna system whose radiation characteristics can be changed by the network after deployment and adapted to, e.g., current traffic needs. For example, the antenna system can be reconfigured to better serve a traffic hotspot by, e.g., increasing the antenna gain toward the hotspot. In this context, the term “hotspot” refers to a certain area, a hotspot area, where there are more user terminals than in the rest of a certain coverage area, for example a cellular sector.

For the above reason, and also for other reasons, it is of interest to identify that there is a hotspot; and, if applicable, find a direction towards the hotspot.

If the size of a hotspot area is of the same order as the cell size, the hotspot can be detected and located by simply monitoring the traffic load in different cells.

This is, however, not possible if the size of a hotspot area is considerably smaller than the cell size, e.g., in a macro deployment, since the average load in the cell can be moderate although there is high traffic load in a small part of the cell. Furthermore, it is not possible to locate in which part of the cell the hotspot is located using this approach.

Reconfigurable antennas can be controlled blindly without knowledge of a possible hotspot by simply testing different parameter settings and try to find the best one.

A disadvantage with blindly controlling reconfigurable antennas is that it may disrupt network operation by trying poor antenna parameter settings that can deteriorate network performance. Another disadvantage is that the convergence time to find the best parameter settings may be prohibitively long, since enough network statistics needs to be collected for each setting in order to take reliable decisions.

### SUMMARY

It is an object of the present invention to provide means for identifying that there is a hotspot; and, if applicable, find a direction towards the hotspot.

Said object is obtained by means of a node 1 in a wireless communication network, the node comprising at least one antenna arrangement. Each antenna arrangement comprises at least two spatially separated antenna functions and is arranged to communicate with a corresponding plurality of user terminals and also to receive information from each one of said user terminals. Said information comprises data enabling the node to control beamforming for each antenna arrangement towards said user terminals. The node comprises a control unit that is arranged to analyze said data and, from the analysis of said data, to determine how said user terminals are distributed within a certain angular span for each antenna arrangement.

Said object is also obtained by means of a method for determining how a plurality of user terminals is distributed within a certain angular span. The method comprises the step of receiving information from each one of said user terminals at a wireless communication network node, said information comprising data enabling the node to control beamforming for an antenna arrangement towards said user terminals. The method further comprises the steps of analyzing said data; and using said analysis to determine how said user terminals are distributed within said certain angular span.

According to an example, the control unit is arranged to determine whether a certain angular direction or angular sub-span is associated with more user terminals than other angular directions or angular sub-spans for each antenna arrangement.

According to another example, the data comprises precoding matrix indicator, PMI, reports.

According to another example, the control unit is arranged to determine how the user terminals are distributed within said certain angular span by analyzing a statistical distribution of the received PMI reports. The control unit may further be arranged to determine whether the distribution of user terminals determined from the PMI reports exceeds a threshold for at least one certain PMI.

According to another example, each antenna function is constituted by a re-configurable antenna function. In this case, the re-configurable antenna functions may be configured in dependence of how the user terminals are distributed according to the analysis.

More examples are disclosed in the dependent claims.

A number of advantages are obtained by means of the present invention, mainly it is made possible to detect and localize hotspots in a macro scenario, such that the direction to the hotspot may be determined with an accuracy that is a fraction of the sector covering angle. This information can then for example be used to increase system performance.

### BRIEF DESCRIPTION OF THE DRAWINGS

The present invention will now be described more in detail with reference to the appended drawings, where:

FIG. 1 shows a schematic side view of a node;

FIG. 2 shows a schematic top view of the node;

FIG. 3 shows a schematic view of an antenna arrangement;

FIG. 4 shows a PMI probability mass function;

FIG. 5 shows a PMI histogram; and

FIG. 6 shows a flowchart for a method according to the present invention.

### DETAILED DESCRIPTION

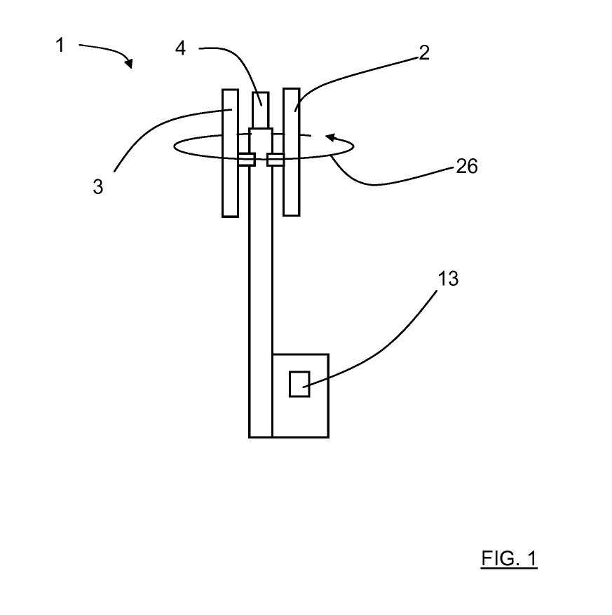

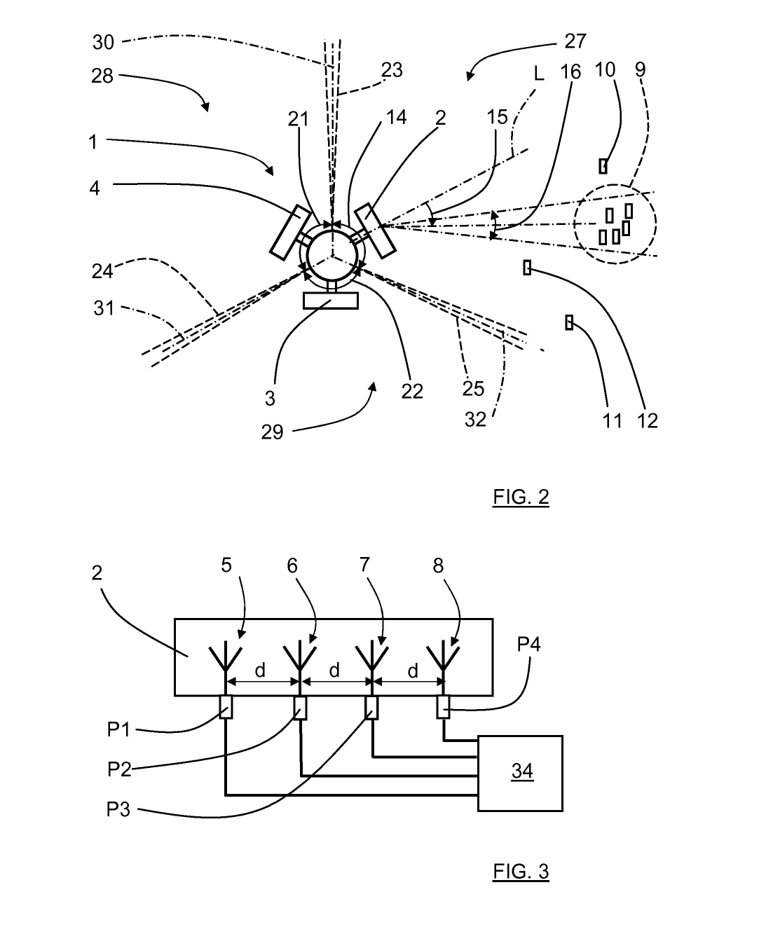

With reference to FIG. 1 and FIG. 2, there is a node 1 in a wireless communication network comprising a first antenna arrangement 2, a second antenna arrangement 3 and a third antenna arrangement 4. Each antenna arrangement 2, 3, 4 is intended to cover a certain corresponding angular sector 27, 28, 29, the sectors 27, 28, 29 being divided by corresponding borders 30, 31, 32. Along the borders 30, 31, 32, corresponding border regions 23, 24, 25 are positioned.

The angular sectors 27, 28, 29 are shown in an azimuth plane 26, and have a respective angular span 14, 21, 22. It should be noted that each antenna arrangement 2, 3, 4 not only has coverage in a single plane, but in a volume, the antenna arrangements 2, 3, 4 having coverage in both azimuth and elevation.

In this example, the first antenna arrangement 2 will be described in further detail, but the following disclosure is applicable for all the antenna arrangements 2, 3, 4, since they are of the same kind. With reference also to FIG. 3, the first antenna arrangement 2 comprises a first antenna function 5, a second antenna function 6, a third antenna function 7 and a fourth antenna function 8, the antenna functions 5, 6, 7, 8 being spatially separated with a certain distance d and being connected to corresponding antenna ports P1, P2, P3, P4. The antenna ports P1, P2, P3, P4 are connected to a beamforming unit 34.

The first antenna arrangement 2 is arranged to communicate with a corresponding plurality of user terminals 9, 10, 11, 12 distributed within an angular span 14 defining a coverage sector for the first antenna arrangement 2. The plurality of user terminals 9, 10, 11, 12 comprises a group 9 of user terminals and three separate user terminals 10, 11, 12, the group 9 being confined within a certain angular sub-span 16. This angular sub-span 16 is mainly positioned in a certain angular direction 15, the group 9 being associated with more user terminals than other angular directions or angular sub-spans. The group 9 thus constitutes a so-called hotspot.

The first antenna arrangement 2 is adapted to receive information from each one of said user terminals 9, 10, 11, 12, said information comprising data enabling the node 1 to control beamforming for the first antenna arrangement 2 towards said user terminals 9, 10, 11, 12.

According to the present invention, the node 1 comprises a control unit 13 that is arranged to analyze said data and, from the analysis of said data, to determine how said user terminals 9, 10, 11, 12 are distributed within the angular span 14 of the first antenna arrangement. In this way, it may be determined that there is a hotspot 9, and the location of the hotspot 9. As mentioned previously, the location of the hotspot 9 may be defined as the angular sub-span 16 within which the hotspot 9 is positioned and/or as the certain angular direction 15 in which the hotspot 9 mainly is positioned.

It will now be described more in detail how the above may be practically achieved.

Multi-antenna transmission techniques are used in several wireless communication standards, e.g. 3GPP (third generation partnership project) LTE (Long Term Evolution), in order to increase system capacity and coverage. A particular transmission mode is codebook-based precoding in which the first antenna arrangement 2 transmits one or several beamformed data streams to the user terminals 9, 10, 11, 12. The beamforming weights are selected from a standardized codebook based on recommendations transmitted from the user terminals 9, 10, 11, 12.

In order for the user terminals 9, 10, 11, 12 to be able to recommend beamforming weights, the first antenna arrangement 2 first transmits pre-determined reference signals which are used by the user terminals 9, 10, 11, 12 to estimate the complex channel matrix between the first antenna arrangement 2 and the user terminals 9, 10, 11, 12. This estimate can then be used to determine which weights in the codebook that will result in the best performance for the current channel state. Since there only is a finite number of eligible beamforming weights as dictated by the codebook, only an index needs to be transmitted back to the base station, referred to as a precoding matrix indicator (PMI). The previously described data sent by the user terminals 9, 10, 11, 12, enabling the node 1 to control beamforming for the first antenna arrangement 2 towards said user terminals 9, 10, 11, 12, comprises PMI reports.

Since the first antenna arrangement 2 comprises at least two spatially separated antenna functions 5, 6, 7, 8, which is a requirement, a beamforming weight vector can be translated to a direction in which a signal will be transmitted if this vector is applied on the antenna functions 5, 6, 7, 8. For this to be possible, the antenna arrangement 2, including radio branches and possible feeder cables, must be coherent, i.e., the phase relations between the different antenna functions 5, 6, 7, 8 must be known. This is a requirement that may anyway be imposed by other features, e.g., coherency is needed to achieve the full potential of beamforming. Therefore, this does not necessarily impose any additional requirements on calibration or characterization.

A beamforming weight vector w is for example expressed in the form

w=[exp(jφ₁) Λ exp(jφ_{K})]. (1)

For a uniform linear array (ULA) the phases φₖ are given by

$${φ}_{k} = \frac{2 π {f}_{0} {d}_{k}}{c} sin {θ}_{0} , \qquad ( 2 )$$

where dₖ is the distance of the k-th antenna function from a chosen reference point, f₀ is the carrier frequency and c is the speed of light. This weight vector will then produce a beam with a pointing direction θ₀ given by

$${θ}_{0} = arcsin ( \frac{c {φ}_{k}}{2 π {f}_{0} {d}_{k}} ) . \qquad ( 3 )$$

By analyzing statistics of PMI reports it is possible to acquire an understanding of where the user terminals 9, 10, 11, 12 are located, or at least knowledge about which the most favorable directions are. If a user terminal 9, 10, 11, 12 recommends a certain PMI, this means that there is a strong path between the base station and the user terminal 9, 10, 11, 12 in question in the corresponding direction, whether it be a direct path or a reflected path. If many user terminals 9 report the same PMI, this is an indication that there are many user terminals 9 in the corresponding direction 15. This could be an indication of a hotspot. Even if it is not a hotspot, it is still an indication of in which direction the first antenna arrangement 2 should transmit its energy. This information can be used to control a so-called reconfigurable antenna to concentrate its radiated energy in this direction. The benefits of this are two-fold: increased signal energy to the desired user terminals 9 and reduced interference to other user terminals 10, 11, 12. In order to maintain a sufficient signal to the other user terminals 10, 11, 12, they may be served by another sector 28, 29 in order to balance the load between the sectors 27, 28, 29.

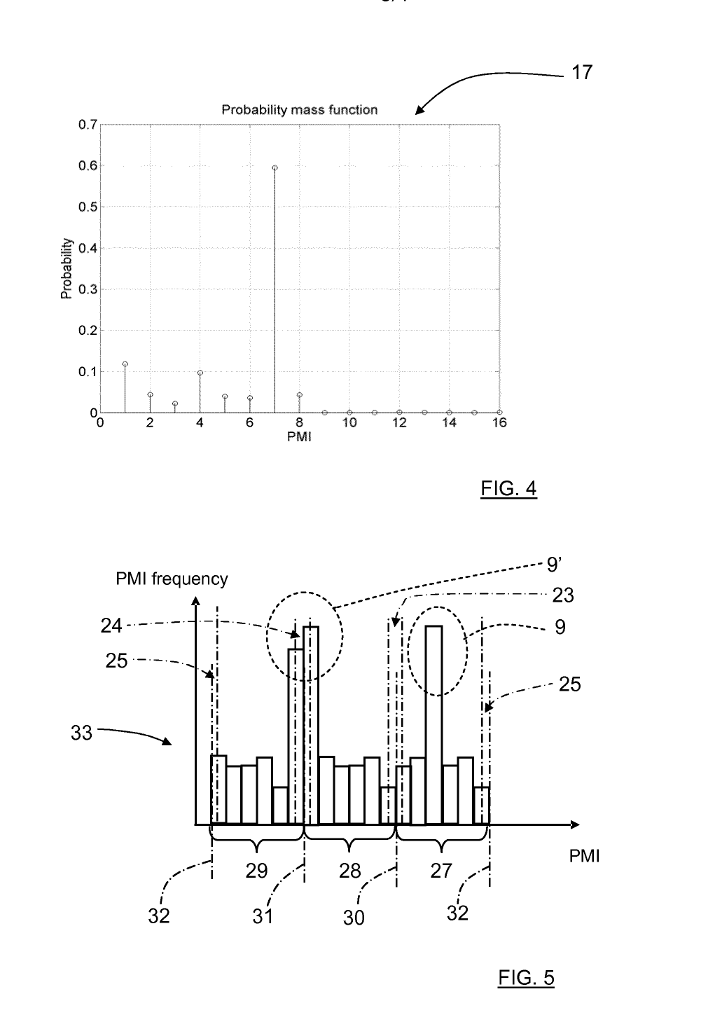

FIG. 4 shows a probability mass function with PMI probability on the y-axis and PMI on the x-axis. With reference to FIG. 2 and FIG. 4, the control unit 13 is thus arranged to determine how the user terminals 9, 10, 11, 12 are distributed within said certain angular span 14 by analyzing a statistical distribution 17 of the received PMI reports, the PMI having the value 7 being dominant in this example.

FIG. 5 shows concatenated PMI histograms 33 of three adjacent sectors 27, 28, 29 with PMI frequency on the y-axis and PMI on the x-axis. Here, the hotspot 9 in the angular sector 27 associated with the first antenna arrangement 2 is shown, as well as a further hotspot 9′ positioned at a border region 24 between of adjacent sectors 28, 29. How the border region hotspot 9′ may be handled is discussed later.

In this example, with reference to FIG. 3, each antenna function 5, 6, 7, 8 is in the form of a so-called a reconfigurable antenna constituting an antenna system where each antenna port can be reconfigured. Such a reconfigurable antenna system could be implemented by, e.g., active array technology or by stacking several conventional reconfigurable antennas next to one another. Reconfigurable antennas are well-known in the art, and will not be further described here.

By having reconfigurable antenna functions 5, 6, 7, 8, it is possible to change the angular size and direction of the angular sectors 27, 28, 29 by moving the borders 30, 31, 32.

A procedure according to the present invention may comprise the following steps:
1. Calculate statistics of PMI reports received from user terminals 9, 10, 11, 12, e.g., histogram 33 as shown in FIG. 5 or probability mass function (PMF) 7 as shown in FIG. 4. This could be done using a sliding window in time so that the collected data have not been outdated while still containing sufficiently many reports to be statistically reliable.
2. Check the histogram 33 or PMF 7 if the reports are concentrated to one or a few PMI:s. This would indicate that user terminals 9 are clustered in a hotspot. The detection of a PMI concentration could, e.g., be based on that a number of reports for a particular PMI should exceed a certain fixed threshold percentage or that the ratio of the number of reports for one PMI and its neighbors exceeds some value. In FIG. 4, the PMI of the value 7 seems to be dominant.
3. Determine the direction 14 to the hotspot 9 by relating the phases in the weight vector for the dominating PMI to the antenna element positions and the carrier frequency, and also possible calibration factors, according to equation (3).

The settings of the reconfigurable antenna functions 5, 6, 7, 8 can then be changed so that the transmitted energy is concentrated to the hotspot 9, e.g., set the beam pointing direction to the estimated direction of arrival (DOA), in this example the angular direction indicated with 14 in FIG. 2. To further increase the antenna gain to the hotspot 9, and minimize the energy transmitted in unwanted directions, the half-power beamwidth (HPBW) can also be set to a lower value. This value can be set based on how concentrated the PMI histogram is. It is still desired to maintain a sufficient overall coverage.

The method can be applied in an individual cell, in a site, or in a coordinated manner among several sites. Applying the method in a site with several cells or sectors makes it easier to detect and localize hotspots 9′ near the sector border since the hotspot will show up in the PMI histograms of both cells 28, 29 on either side of the border 31, as shown in FIG. 5. The antenna configuration can then be coordinated so that beams from only one cell are directed to the hotspot 9′.

Generally, an analysis is made for the antenna arrangements 2, 3, 4 at the node 1, all such analyses being used for correlation at the border regions 23, 24, 25 of each angular span 14, 21, 22. The size of each border region 23, 24, 25 is not exactly defined, but preferably corresponds to two adjacent PMI:s.

The basic idea of the invention is to utilize user terminal feedback in order to detect and localize potential hotspots in a macro scenario. With this approach it is possible to detect a small hotspot 9 and determine the direction 15 to the hotspot 9 with an accuracy that is a fraction of the sector covering angle 14.

This information can for example be used to adjust reconfigurable antenna parameters in order to increase system performance without the need of trying out different settings that could potentially deteriorate network performance. The information provided by the proposed method could also be used as input to a SON (Self-Organizing Network) algorithm for controlling reconfigurable antennas and other SON components.

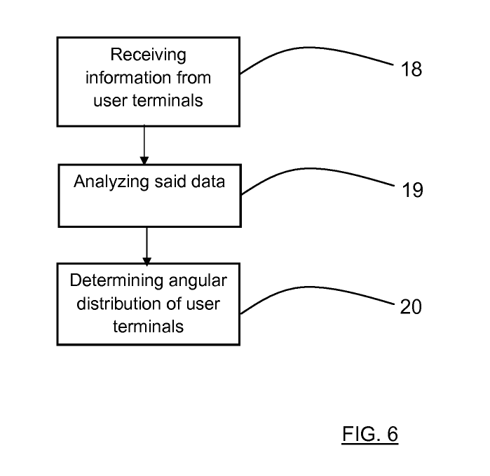

With reference to FIG. 6, the present invention also relates to a method for determining how a plurality of user terminals 9, 10, 11, 12 is distributed within a certain angular span 14, the method comprising the steps:

18: receiving information from each one of said user terminals 9, 10, 11, 12 at a wireless communication network node 1, said information comprising data enabling the node 1 to control beamforming for an antenna arrangement 2, 3, 4 towards said user terminals 9, 10, 11, 12;

19: analyzing said data; and

20: using said analysis to determine how said user terminals 9, 10, 11, 12 are distributed within said certain angular span 14.

The present invention is not limited to the examples above, but may vary freely within the scope of the appended claims. For example, the node 1 may be of any suitable type, for example a base station or a repeater.

The antenna functions 5, 6, 7, 8 may be reconfigurable as described above, but this is not necessary. Controlling antenna functions by means of the detected hotspot is one of several applications of the present invention.

The antenna arrangements 2, 3, 4 may be of any suitable kind and are here shown arranged for sector coverage. Each antenna arrangement 2 comprises at least two spatially separated antenna functions 5, 6, 7, 8.

The term “hotspot” refers to a certain area, a hotspot area, where there are more user terminals than in the rest of a certain coverage area, for example a cellular sector. The definition of a hotspot may vary, but in essence a hotspot is a concentration of user terminals to such a degree that its existence and position is of interest, for example when controlling reconfigurable antennas. Generally, the control unit 13 is arranged to determine whether a certain angular direction 15 or angular sub-span 16 is associated with more user terminals than other angular directions or angular sub-spans for each antenna arrangement 2, 3, 4.

1. A node in a wireless communication network, the node comprising:
an antenna arrangement comprising at least two spatially separated antenna functions, the antenna arrangement being arranged to communicate with a plurality of user terminals and to receive information from each one of said user terminals, said information comprising data enabling the node to control beamforming for the antenna arrangement towards said user terminals; and
a control unit arranged to analyze said data and, from the analysis of said data, to determine how said user terminals are distributed within a certain angular span for the antenna arrangement.

2. The node of claim 1, wherein, from the analysis of said data, the control unit is arranged to determine whether a certain angular direction or angular sub-span is associated with more user terminals than other angular directions or angular sub-spans for the antenna arrangement.

3. The node of claim 2, wherein the control unit is arranged to correlate the obtained results for a plurality of antenna arrangements at border regions of each angular span.

4. The node of claim 1, wherein the data comprises precoding matrix indicator, PMI, reports.

5. The node of claim 4, wherein the control unit is arranged to determine how the user terminals are distributed within said certain angular span by analyzing a statistical distribution of the received PMI reports.

6. The node of claim 5, wherein the control unit is arranged to determine whether the distribution of user terminals determined from the PMI reports exceeds a threshold for at least one certain PMI.

7. The node of claim 1, wherein each antenna function is comprises a re-configurable antenna function.

8. The node of claim 7, wherein said re-configurable antenna functions are configured in dependence of how the user terminals are distributed according to the analysis.

9. A method for determining how a plurality of user terminals is distributed within a certain angular span, the method comprising the step:
receiving information from each one of said user terminals at a wireless communication network node, said information comprising data enabling the node to control beamforming for an antenna arrangement towards said user terminals;
analyzing said data; and
using said analysis to determine how said user terminals are distributed within said certain angular span.

10. The method of claim 9, wherein the step of using said analysis to determine how said user terminals are distributed within said certain angular span further comprises determining whether a certain angular direction or sub-span is associated with more user terminals than other angular directions or sub-spans.

11. The method of claim 9, wherein the data used comprises precoding matrix indicator, PMI, reports.

12. The method of claim 11, wherein the method further comprises the step of determining how the user terminals are distributed within a certain angular span by analyzing a statistical distribution of the received PMI reports.

13. The method of claim 12, wherein the method further comprises the step of determining whether the distribution of user terminals determined from the PMI reports exceeds a threshold for at least one certain PMI.

14. The method of claim 9, wherein each antenna function comprises a re-configurable antenna function.

15. The method of claim 9, wherein said analysis is used for configuring said re-configurable antenna functions.

16. The method of claim 9, wherein said analysis is made for each of a plurality of antenna arrangements at the node, all such analyses being used for correlation at border regions of each angular span.
